(19) United States
(12) Patent Application Publication
(10) Pub. No.: US 2011/0210113 A1
(43) Pub. Date: Sep. 1, 2011

(54) CONVEYOR OVEN AND FRAME WITH COOLING

(75) Inventor: Jason Edward Lauer, Fort Wayne, IN (US)

(73) Assignee: MERCO/SAVORY LLC

(21) Appl. No.: 13/034,846

(22) Filed: Feb. 25, 2011

Related U.S. Application Data
(60) Provisional application No. 61/308,555, filed on Feb. 26, 2010.

(51) Int. Cl. H05B 1/00

(52) U.S. Cl. 219/209

(57) ABSTRACT

A conveyor oven having a hollow conveyor frame that supports a conveyor belt within an oven chamber of the oven. A cooling fan draws air from ambient that flows through the hollow conveyor frame to cool its exterior surface to prevent harm to an operator of the oven. The cooling air may also flow through passages adjacent other exterior surfaces of the oven.

### RELATED APPLICATION

This application claims the benefit of U.S. Provisional Application Ser. No. 61/308,555, filed Feb. 26, 2010, the entire contents of which are incorporated herein by reference.

### BACKGROUND

1. Field of the Disclosure

The present disclosure relates generally to a conveyor oven and method and, in particular, to a conveyor oven and method with cooled exterior surfaces.

2. Description of Related Art

Conveyorized ovens include a conveyor belt that moves food from a position where a user places the food on a conveyor belt through an oven cavity where the food is cooked and out of the oven cavity to be retrieved by the user. Most conveyor frames on conveyorized ovens, for example, toasters, do not have to worry about getting too hot because the ambient air in the room is enough to keep it cool. Most conveyorized toasters do not operate at a temperature high enough to heat the conveyor frame above 140 degrees Fahrenheit. It is desirable to reduce a time required for heating food in an oven. Such time requirements would require use of more wattage that causes heat in the oven cavity where the food is heated to escape and undesirably conduct into the conveyor frame, which can cause injury should a user contact the frame.

Accordingly, there is a need for a conveyor oven and method with cooling of external surfaces for user safety.

### SUMMARY OF THE DISCLOSURE

An embodiment of a conveyor oven according to the present disclosure comprises a housing defining an oven chamber with an inlet. A conveyor extends through the inlet into the oven chamber and comprises a conveyor belt. A hollow conveyor frame defines a passage and surrounds an end of the conveyor belt that extends outside the inlet. A heating element supplies heat to cook food product on the conveyor belt. A fan is in fluid communication with the passage and draws air from ambient to flow through the passage to cool the hollow conveyor frame.

In another embodiment of the conveyor oven of the present disclosure, there is provided one or more apertures through which the air flows to ambient after passing through the passage of the hollow conveyor frame.

In another embodiment of the conveyor oven of the present disclosure, at least one of the apertures is located in the hollow conveyor frame.

In another embodiment of the conveyor oven of the present disclosure, the housing comprises a first side wall that has an interior wall and an exterior wall defining a first side wall passage that is in fluid communication with the passage of the hollow conveyor frame. The air from ambient also flows through the first side wall passage to cool the exterior wall.

In another embodiment of the conveyor oven of the present disclosure, the housing comprises a second side wall that has an interior wall and an exterior wall defining a second side wall passage that is in fluid communication with the passage of the hollow conveyor frame. The air from ambient also flows through the second side wall passage to cool the exterior wall.

In another embodiment of the conveyor oven of the present disclosure, the conveyor oven further comprises a bottom compartment that is disposed below the oven chamber and that is in fluid communication with the passage. At least one aperture to ambient is disposed in the bottom compartment. The fan is disposed in the bottom compartment to draw the air from ambient via the aperture.

In another embodiment of the conveyor oven of the present disclosure, the conveyor oven further comprises a tray disposed remotely of the inlet. The conveyor belt conveys the food product through the inlet and the oven chamber and delivers the food product to the tray.

In another embodiment of the conveyor oven of the present disclosure, the tray is at least partly disposed outside the oven chamber.

An embodiment of a method according to the present disclosure cools one or more surfaces of a conveyor oven. Heat is applied to a conveyor that extends through the inlet into an oven chamber of the conveyor oven and that comprises a conveyor belt. An end of the conveyor belt that extends outside the inlet is surrounded with a hollow conveyor frame defining a passage. A fan is in fluid communication with the passage and draws air from ambient to flow through the passage to cool the hollow conveyor frame.

In another embodiment of the method of the present disclosure, the method further comprises flowing the air through one or more apertures to ambient after passing through the passage of the hollow conveyor frame.

In another embodiment of the method of the present disclosure, at least one of the apertures is located in the hollow conveyor frame.

In another embodiment of the method of the present disclosure, the conveyor oven further comprises one or more side walls, each of which includes an interior wall and an exterior wall defining a side wall passage that is in fluid communication with the passage of the hollow conveyor frame. The air from ambient also flows through the side wall passage to cool the exterior wall.

In another embodiment of the method of the present disclosure, the fan is disposed in a bottom compartment that is located below the oven chamber and that is in fluid communication with the passage. The fan draws air from ambient via at least one aperture disposed in the bottom compartment.

The above-described and other advantages and features of the present disclosure will be appreciated and understood by those skilled in the art from the following detailed description and drawings.

### BRIEF DESCRIPTION OF THE DRAWINGS

FIG. 1 is a top side perspective view of a conveyor oven according to the present disclosure.

FIG. 2 is a schematic top view of the conveyor oven of FIG. 1.

FIG. 3 is a schematic side view of the conveyor oven of FIG. 1.

FIG. 4 is a schematic front view of the oven conveyor oven of FIG. 1.

FIG. 5 is a bottom side perspective view of the conveyor oven of FIG. 1 with a top tilted from the bottom compartment.

FIG. 6 is a bottom front perspective view of the conveyor oven of FIG. 1 with a top tilted from the bottom compartment.

FIG. 7 is a schematic top side perspective view of the conveyor oven of FIG. 1 having a first side wall removed.

FIG. 8 is a schematic top side perspective view of the conveyor oven of FIG. 1 having a second side wall removed.

FIG. 9 is a schematic partial top side perspective view of the conveyor oven of FIG. 1 having the second side wall removed.

FIG. 10 is a schematic exploded view of the conveyor oven of FIG. 1.

FIG. 11 is a schematic exploded view of the conveyor frame of the conveyor oven of FIG. 1.

FIG. 12 is a schematic bottom view of the conveyor oven of FIG. 1 indicating an airflow path.

FIG. 13 is a schematic top side perspective view of the conveyor oven of FIG. 1 having the first side wall removed indicating the airflow path.

FIG. 14 is a schematic top side perspective view of the conveyor oven of FIG. 1 having the second side wall removed indicating the airflow path.

FIG. 15 is a schematic front side perspective view of the conveyor oven of FIG. 1 having the second side wall removed indicating the airflow path.

### DETAILED DESCRIPTION OF THE PREFERRED EMBODIMENT

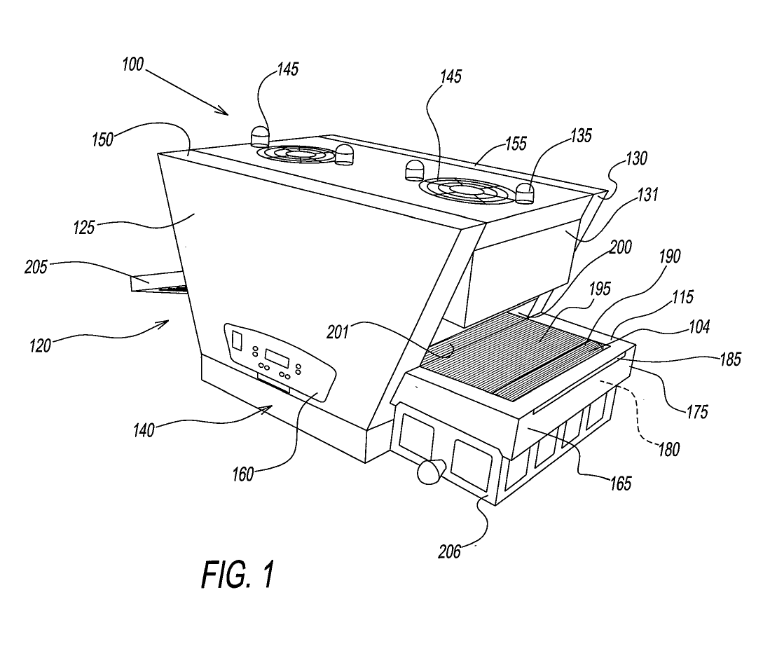

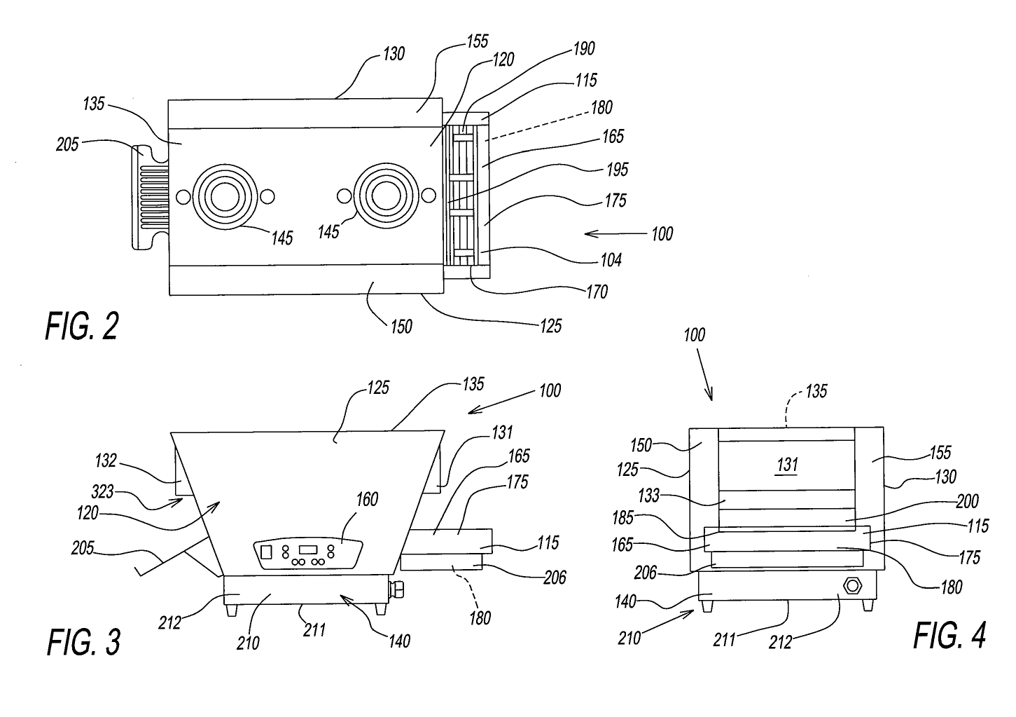

Referring to the drawings and in particular to FIGS. 1-4, an exemplary embodiment of a conveyor oven according to the present disclosure is generally referred to by reference numeral 100. Conveyor oven 100 comprises a conveyor 104, a housing 120 and a conveyor frame 115. Housing 120 has a first side wall 125, a second side wall 130, a first front wall 131, a rear wall 132, a second front wall 133, a bottom wall 225 and a top wall 135 that define an oven cavity or oven chamber 200 having an inlet 201 and an outlet 323. Housing 120 is connected to a bottom compartment 140. Top wall 135 has apertures 145. First side wall 125 covers a first compartment or side wall passage 150. Second side wall 130 covers a second compartment or side wall passage 155. A user interface 160 is disposed on first side wall 125. A user can use user interface 160 to enter data for cooking instructions or other data for conveyor oven 100. Conveyor 104 comprises a conveyor belt 195 that extends through inlet 201 into oven chamber 200 and is supported by housing 120. Conveyor frame 115 surrounds at least a portion of conveyor belt 195 that is outside inlet 201.

Conveyor frame 115 is hollow as defined by an outer wall assembly 165 and an inner wall assembly 170 that form a frame compartment or passage 175 having an interior volume 180 therebetween. Outer wall assembly 165 has apertures 185 therethrough allowing fluid communication between interior volume 180 and an ambient environment surrounding conveyor frame 115. Inner wall assembly 170 is connected to a drive shaft assembly 190, which moves conveyor belt 195. Food is placed on conveyor belt 195 by a user so that conveyor belt 195 moves the food from a position within conveyor frame 115 through oven chamber 200 to a rear tray 205. Conveyor frame 115 may be connected above an external crumb tray 206 that collects any loose debris or particles from conveyor belt 195 due to the user placing food product on conveyor belt 195.

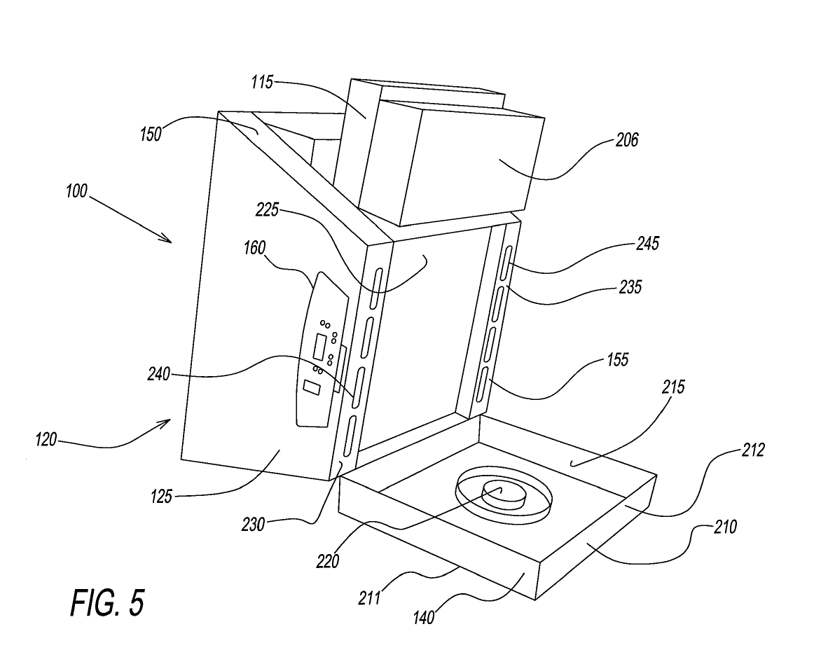

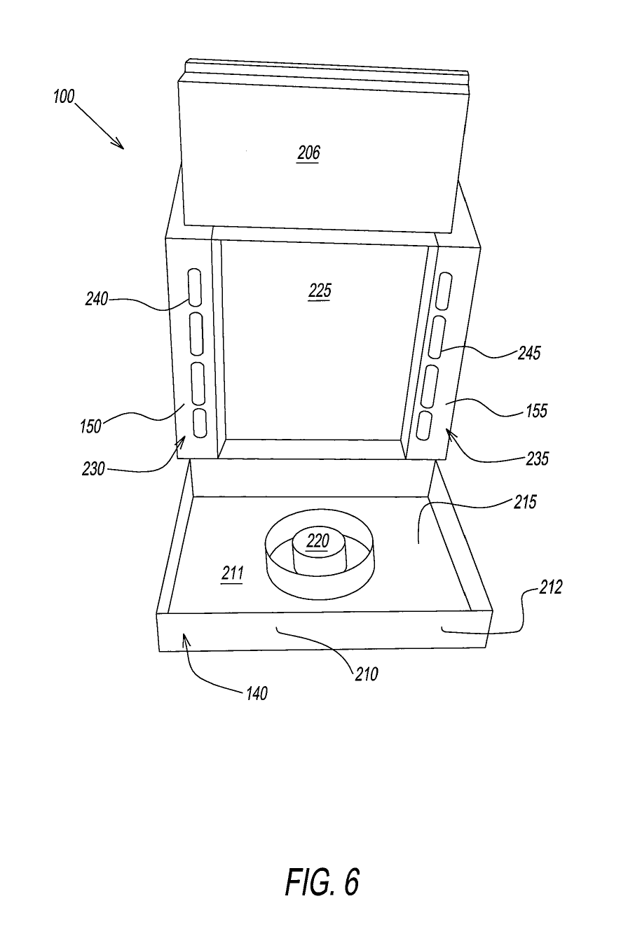

Referring now to FIGS. 3-6, bottom compartment 140 comprises a bottom housing 210 with a base wall 211 and a base side wall 212 forming a bottom interior volume 215 that houses a fan 220. When bottom compartment 140 is connected to housing 120, interior volume 215 is covered by a bottom wall 225 of housing 120 and a first bottom side wall 230 of first compartment 150 and a second bottom side wall 235 of second compartment 155. First bottom side wall 230 has apertures 240 therethrough and second bottom side wall 235 has apertures 245 therethrough to provide fluid communication between interior volume 215 and side wall compartments 150 and 155.

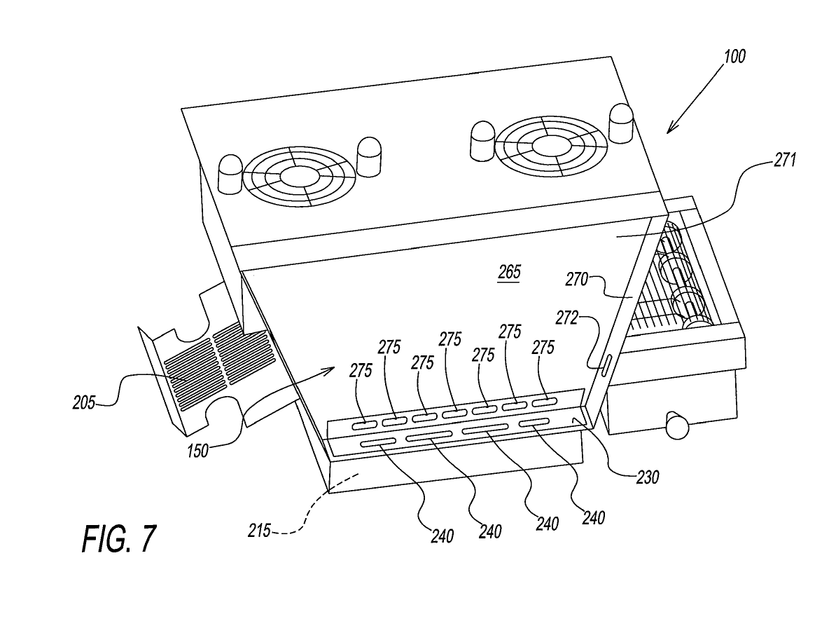

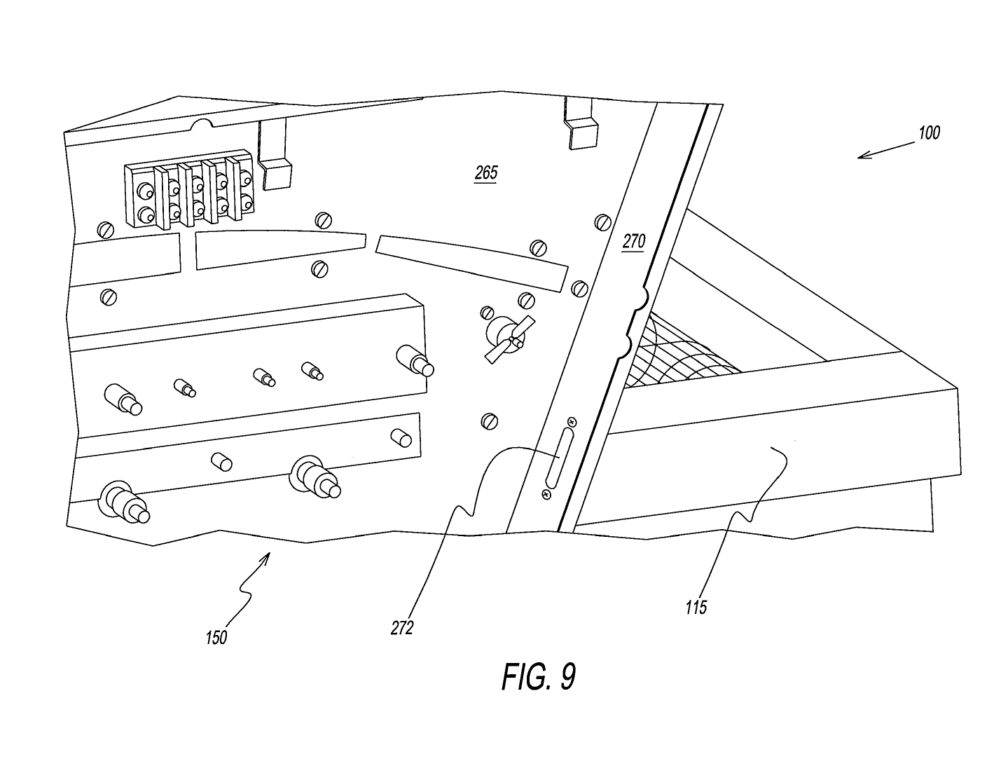

Referring now to FIGS. 7 and 9, first compartment 150 has a first back panel 265 surrounded by a first compartment side wall 270 forming a first compartment interior 271. First back panel 265 has apertures 275 therethrough adjacent an edge that connects to first bottom side wall 230. First compartment side wall 270 has an aperture 272 therethrough from first compartment interior 271 to interior volume 180 in conveyor frame 115.

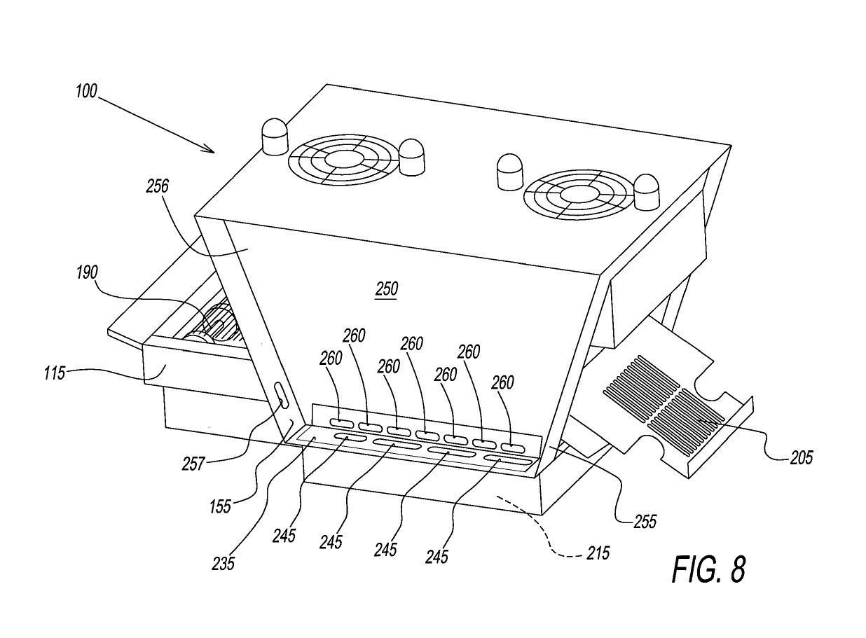

Referring now to FIG. 8, second compartment 155 has a second back panel 250 surrounded by a second compartment side wall 255 forming a second compartment interior 256. Second back panel 250 has apertures 260 therethrough adjacent an edge that connects to second bottom side wall 235. Second compartment side wall 255 has an aperture 257 therethrough from second compartment interior 256 to interior volume 180 in conveyor frame 115.

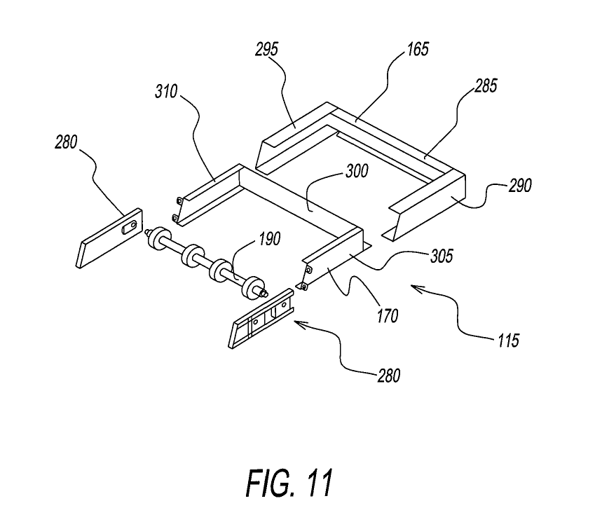

Referring now to FIGS. 1 and 11, conveyor frame 115 has outer wall assembly 165 and inner wall assembly 170 that form a hollow frame compartment or passage 175 having interior volume 180 therebetween. Outer wall assembly 165 and inner wall assembly 170 are connected, for example, by screws, to form interior volume 180 therebetween. Outer wall assembly 165 has an outer front portion 285, a first outer side portion 290, and a second outer side portion 295. Inner wall assembly 170 has an inner front portion 300, a first inner side portion 305, and a second inner side portion 310. First outer side portion 290 and first inner side portion 305 form a first side passage. Second outer side portion 295 and second inner side portion 310 form a second side passage. Outer front portion 285 and inner front portion 300 form a front passage. Outer wall assembly 165 connects to inner wall assembly 170 forming interior volume 180 that is continuous among first side passage, front passage and second side passage. Outer front portion 285 has apertures 185 therethrough as shown in FIGS. 1, 4 and 10. Inner wall assembly 170 is connected to drive shaft assembly 190 by a belt tensioner assembly 280.

Referring to FIGS. 1, 2 and 10, top wall 135 covers a pair of fans (not shown). The pair of fans may be connected to top wall 135. Front wall 131 forms a first duct with a top panel 320 and rear wall 132 forms a second duct with top panel 320. The fans draw air through the first duct and the second duct through the fans and through apertures 145 through top wall 135.

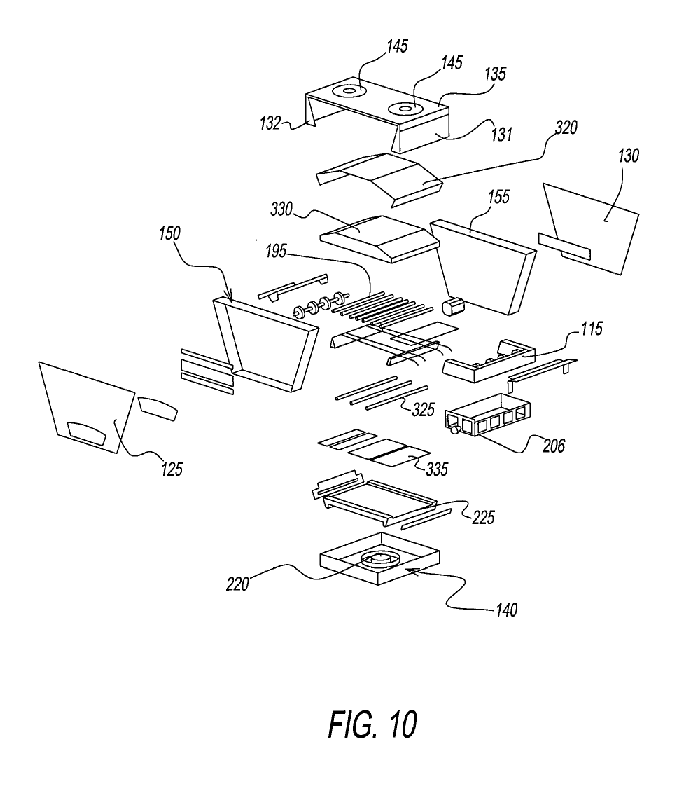

Referring to FIG. 10, heating elements 325 are connected between first compartment 150 and second compartment 155. A reflecting assembly 330 may be positioned between top panel 320 and heating elements 325. An interior crumb tray 335 may be placed between bottom wall 225 and conveyor belt 195.

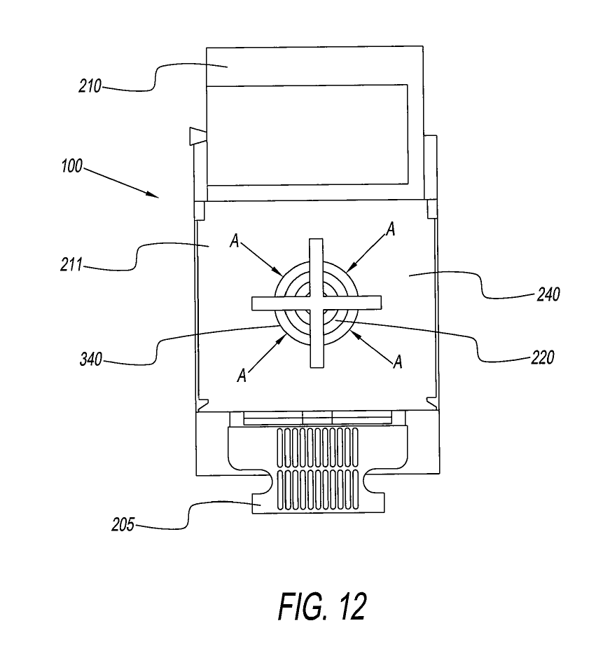

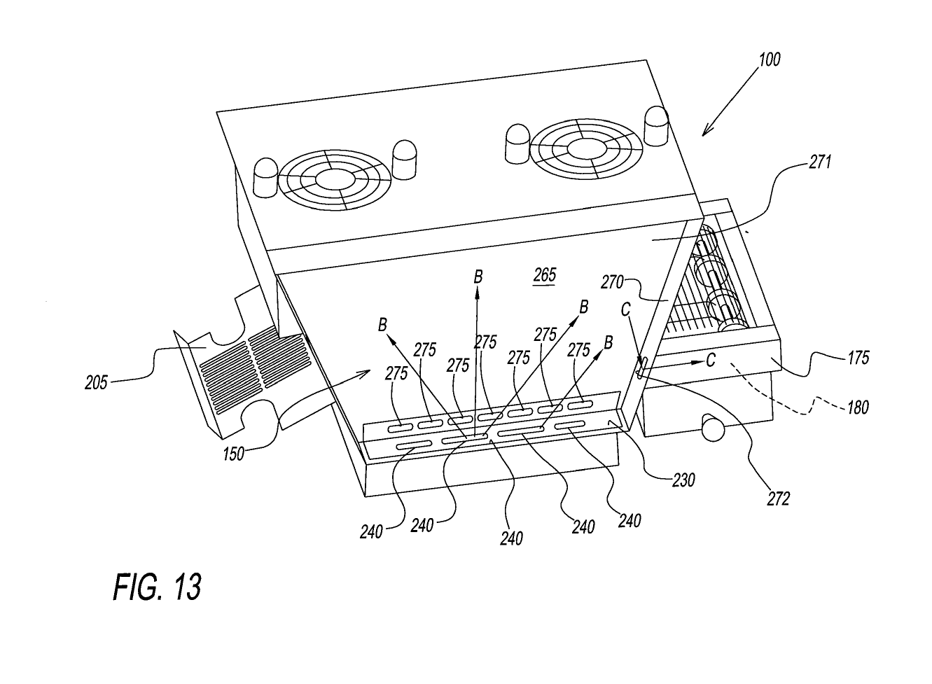

Referring now to FIGS. 12 and 13, base wall 211 has an aperture 340 therethrough that provides fluid communication between bottom interior volume or passage 215 and an ambient environment of oven 100. Fan 220 draws air from the ambient environment through aperture 340, as shown by arrows A, into passage 215 in bottom compartment 140. The air is at a temperature that is lower than a temperature within passage 215. The air passes from passage 215 through apertures 240 in first bottom side wall 230 and apertures 275 in first back panel 265 into first compartment passage 271, as shown by arrows B. The air passes from first compartment passage 271 through aperture 272 in first compartment side wall 270 into passage 180 of frame compartment 175, as shown by arrows C.

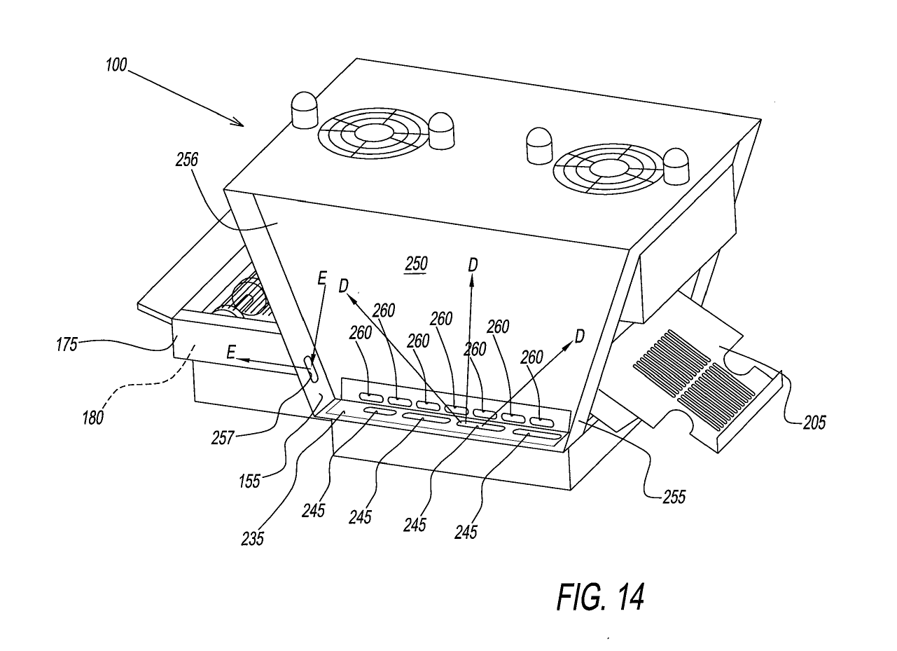

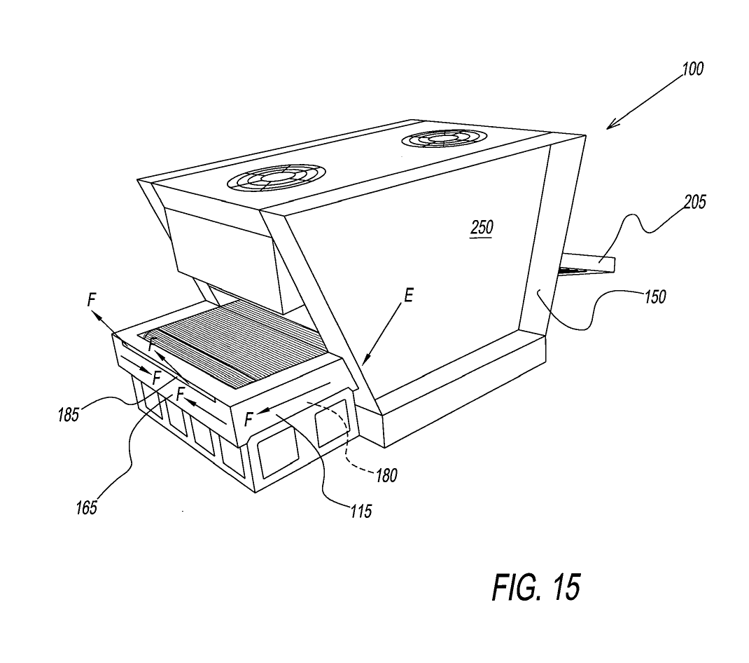

Referring to FIGS. 14 and 15, the air also passes from passage 215 through apertures 240 in second bottom side wall 235 and apertures 260 in second back panel 250 into second compartment passage 256, as shown by arrows D. The air passes from second compartment passage 256 through aperture 257 in second compartment side wall 255 into passage 180 of frame compartment 175, as shown by arrows E. The air flows through passage 180 and exits passage 180 through apertures 185 in outer wall assembly 165, as shown by arrows F. First compartment 150 and second compartment 155 are pressurized with the air cooling first side wall 125, second side wall 130, first back panel 265, first compartment side wall 270, second back panel 256, and second compartment side wall 255. The air flows from a high pressure environment in first compartment 150 and second compartment 155 to a low pressure area in passage 180 cooling conveyor frame 115 so that a user will not be burned by conveyor frame 115 allowing oven 100 to be placed at any height for operation.

The heat required to maintain oven cavity 200 at a desired temperature causes critical sheetmetal components of oven 100 to rise above about 140 degrees Fahrenheit. As a result conveyor frame 115 becomes undesirably too hot and causes injury to the user when touched. Conveyor frame 115 that is hollow with passage 180 allows cool air from first compartment 150 and second compartment 155 to be pulled from first compartment 150 and second compartment 155 through conveyor frame 115 and out apertures 185 at an end of conveyor frame 115. The cool air from first compartment 150 and second compartment 155 transfers heat away from material of conveyor frame 115, for example, sheetmetal.

It should also be noted that the terms “first”, “second”, “third”, “upper”, “lower”, “above”, “below”, and the like may be used herein to modify various elements. These modifiers do not imply a spatial, sequential, or hierarchical order to the modified elements unless specifically stated.

While the present disclosure has been described with reference to one or more exemplary embodiments, it will be understood by those skilled in the art that various changes may be made and equivalents may be substituted for elements thereof without departing from the scope of the present disclosure. In addition, many modifications may be made to adapt a particular situation or material to the teachings of the disclosure without departing from the scope thereof. Therefore, it is intended that the present disclosure not be limited to the particular embodiment(s) disclosed as the best mode contemplated, but that the disclosure will include all embodiments falling within the scope of the appended claims.

What is claimed is:

1. A conveyor oven comprising:
a housing defining an oven chamber with an inlet;
a conveyor that extends through said inlet into said oven chamber and that comprises a conveyor belt;
a hollow conveyor frame that defines a passage and that surrounds an end of said conveyor belt that extends outside said inlet;
a heating element that supplies heat to cook food product on said conveyor belt; and
a fan that is in fluid communication with said passage and that draws air from ambient to flow through said passage to cool said hollow conveyor frame.

2. The conveyor oven of claim 1, further comprising one or more apertures through which said air flows to ambient after passing through said passage of said hollow conveyor frame.

3. The conveyor oven of claim 2, wherein at least one of said apertures is located in said hollow conveyor frame.

4. The conveyor oven of claim 1, wherein said housing comprises a first side wall that has an interior wall and an exterior wall defining a first side wall passage that is in fluid communication with said passage of said hollow conveyor frame, wherein said air from ambient also flows through said first side wall passage to cool said exterior wall.

5. The conveyor oven of claim 4, wherein said housing comprises a second side wall that has an interior wall and an exterior wall defining a second side wall passage that is in fluid communication with said passage of said hollow conveyor frame, wherein said air from ambient also flows through said second side wall passage to cool said exterior wall.

6. The conveyor oven of claim 1, further comprising a bottom compartment that is disposed below said oven chamber and that is in fluid communication with said passage, and at least one aperture to ambient disposed in said bottom compartment, and where said fan is disposed in said bottom compartment to draw said air from ambient via said aperture.

7. The conveyor oven of claim 1, further comprising a tray disposed remotely of said inlet, and wherein said conveyor belt conveys said food product through said inlet and said oven chamber and delivers said food product to said tray.

8. The conveyor oven of FIG. 7, wherein said tray is at least partly disposed outside said oven chamber.

9. A method for cooling one or more surfaces of a conveyor oven comprising:
applying heat to a conveyor that extends through said inlet into an oven chamber of said conveyor oven and that comprises a conveyor belt;
surrounding an end of said conveyor belt that extends outside said inlet with a hollow conveyor frame defining a passage; and
operating a fan that is in fluid communication with said passage and that draws air from ambient to flow through said passage to cool said hollow conveyor frame.

10. The method of claim 9, further comprising flowing said air through one or more apertures to ambient after passing through said passage of said hollow conveyor frame.

11. The method of claim 10, wherein at least one of said apertures is located in said hollow conveyor frame.

12. The method of claim 9, wherein said conveyor oven further comprises one or more side walls, each of which includes an interior wall and an exterior wall defining a side wall passage that is in fluid communication with said passage of said hollow conveyor frame, wherein said air from ambient also flows through said side wall passage to cool said exterior wall.

13. The method of claim 9, wherein said fan is disposed in a bottom compartment that is located below said oven chamber and that is in fluid communication with said passage, and wherein said fan draws air from ambient via at least one aperture disposed in said bottom compartment.
